(19) United States
(12) Patent Application Publication
(10) Pub. No.: US 2014/0373677 A1
(43) Pub. Date: Dec. 25, 2014

(54) Process for Carbothermic or Electrothermic Production of Crude Iron or Base Products

(71) Applicant: ECOLOOP GmbH, Goslar (DE)

(72) Inventors: Thomas Stumpf, Bad Harzburg (DE); Leonhard Baumann, Aldersbach (DE); Roland Moller, Bad Harzburg (DE)

(21) Appl. No.: 14/365,339

(22) PCT Filed: Dec. 7, 2012
(86) PCT No.: PCT/EP2012/005048

§ 371 Date: Sep. 5, 2014

(30) Foreign Application Priority Data
Dec. 16, 2011 (DE) 10 2011 121 507.0

(51) Int. Cl. C21B 5/00; C21B 11/10; C21B 5/06; C01B 3/02

(52) U.S. Cl. CPC C21B 5/007; C01B 3/02; C21B 11/10; C21B 5/06; C01B 2203/0255; C01B 2203/0233; C01B 2203/06; C01B 2203/042; C21B 2100/02; C21B 2100/04
USPC 75/10.38; 252/373; 75/471; 75/10.41; 75/468

(57) ABSTRACT

A process serves for the carbothermic/electrothermic production of crude iron or other base products in furnaces (23) by using mixtures comprising iron ore, oxides and/or carbonates of calcium (A) and carbonaceous materials, with formation of carbon monoxide-containing gases. In order to provide a novel process having an increased level of energy efficiency which provides high quality grade synthesis gas, it is proposed that the iron ore and/or the oxides and/or carbonates of calcium are, in whole or in part, first used as bulk material together with organic materials (3) in an upstream vertical moving-bed reactor (2) constructed as a counterflow gasifier, which moving-bed reactor has a bulk material at least in part comprising alkaline substances as moving bed, and a reduction (12) and oxidation zone (6), the organic materials are in whole or in part converted to synthesis gas (9) by gasification with oxygen-containing gases (8) and the remaining bulk material (22) is at least in part provided as raw material mixture for the carbothermic production of crude iron or electrothermic production of base products.

The invention relates to a process for carbothermic/electrothermic production of crude iron or other primary products in blast furnaces or electric low shaft furnaces by using mixtures comprising iron ore, oxides and/or carbonates of calcium and carbon-containing materials, forming carbon monoxide-containing gases. When in the context of this invention the term crude iron is used, what is to be understood by it is not only classical crude iron but also ferrosilicon and ferromanganese. When in the context of this invention electrothermic processes for producing primary products are mentioned, what is to be understood by this is not only the production of calcium carbide but also the production of ferrosilicon, ferromanganese, and silicon.

Carbothermic processes for producing crude iron are performed in shaft furnaces, so-called blast furnaces; iron ores (Fe₂O₃ hematite/Fe₃O₄ magnetite/FeO wuestite) are handled in the blast furnace process along with carbon, as a rule in the form of coke, in countercurrent with air at temperatures of 200 to 2000° C. In the process, the iron oxides are reduced in a reduction zone to elemental iron. Essentially, synthesis gas (reduction gas) functions as the reducing agent; as its primary components, it has carbon monoxide (CO) and hydrogen (H₂), and it is formed by Boudouard reaction and water gas reaction under reductive conditions in the blast furnace. The crude iron is then tapped in molten form at the lower end of the blast furnace, as a result of which a vertical flow of the materials through the shaft is generated.

The carbon used must be used in the form of coke, which is obtained from coal in an upstream coking process. For technical reasons, the use of alternative, at present low-CO₂ carbon bearers (plastics/biomasses) is limited. They are merely blown in, in partial amounts, at a suitable point. The coking of the coal is necessary in order to remove the proportion of volatile carbon ingredients, such as water and low-molecular hydrocarbons, so that the necessary temperatures can be reached in the blast furnace.

One essential reason for the upstream coking, however, is also that the sulfur contained in the coal must be depleted in the coking process. Even slight amounts of sulfur dioxide (SO₂), of approximately 5 to 50 ppm in the reduction gas, do initially speed up the breakdown of oxygen considerably. However, as soon as the first metal iron occurs, the process reverses itself, and the oxygen breakdown is slowed down sharply. The reason for this reaction is the property of the sulfur to bond superficially to the metal iron and thereby prevent the uptake of carbon (carburizing).

The reaction of the iron oxide FeO (wuestite) with CO typically extends not only over the surface of the FeO but also over the surface of the iron that has already been precipitated out. Because of the better absorption behavior of iron, a large proportion of the gas transport from and to the phase boundary between iron and iron oxide takes place via the same iron. However, this happens only if the iron has been able to take up sufficient carbon (to carburize). If the uptake of carbon from the sulfur is blocked, then the reduction can take place only at the surface of the iron oxide.

An even more substantial problem is that even the slightest amounts of sulfur in the end product, steel, cause it to become brittle, thus gradually adversely affecting the otherwise advantageous material properties.

The sulfur problem also requires the pretreatment of the iron ores used by means of so-called roasting, as a result of which metal sulfides that are contained are converted by oxidation and reduction procedures into metal oxides.

Both the coking of coal and the roasting of the ores does lead to a pronounced depletion of the sulfur input into the blast furnace process; however, residues of sulfur compounds that are still present require the use of considerable quantities of oxides and/or carbonates of calcium as a desulfurizing means that binds the sulfur in an additional melting phase.

Shaft furnaces, so-called cupola furnaces, are employed in scrap iron resmelting processes as well. Here again, coke from the coking process is used, so that under reductive conditions, again in countercurrent with air as the oxidation gas, the requisite temperatures of up to 1600° C. can be reached. The molten iron is then tapped at the lower end of the cupola furnace.

Electrothermic processes for producing primary products are performed in shaft furnaces, so-called electric low shaft furnaces.

Electric low-shaft furnaces comprise a crucible-like furnace vessel, which is provided with fireproof linings. Moreover, such furnaces are usually provided with a lid, which contains water-cooled elements and/or fireproof linings. For generating the requisite thermal energy, electric low shaft furnaces have electrodes, which are of Söderberg compound and are constantly resupplied to the furnace in a self-baking process at the rate at which they wear down. By way of these electrodes, the raw materials are heated in the furnace to reaction temperature by means of current-fed resistance heating.

For decades, calcium carbide has been an important basic chemical that functions for instance as a precursor of acetylene as a coal-based raw material as a basis for many chemical daughter products.

In the case of calcium carbide, the electric low shaft furnace is charged with a stoichiometric mixture of quick lime (calcium oxide) and different types of coke, usually continuously.

The heating is effected by the electric current supplied via the Söderberg electrodes. The resistance heating requires a transformation of the current from the high-voltage range down to 200 to 300V, resulting in enormous current intensities of up to 140000 amperes. At the tips of the electrodes, the melting zone then develops, where the melting or reaction process takes place at 1700 to 2500° C.

This causes a thermal breakdown of calcium oxide (CaO). The resultant breakdown products flow upward as gaseous calcium and oxygen and react in the bulk material bed with carbon to form calcium carbide (CaC₂) and carbon monoxide (CO). In such processes, calcium carbide of approximately 75 to 85% purity is usually obtained. The carbide furnace gas (synthesis gas) that occurs as a co-product contains approximately 60 to 80 vol. % carbon monoxide and approximately 10 to 30 vol. % hydrogen (H₂). However, the composition of the synthesis gas depends very substantially on the qualities of coke used, since volatile ingredients contained in them, such as organic ingredients, are released in the carbide process by pyrolysis and are then found in the synthesis gas, for instance in the form of short-chain hydrocarbons.

The calcium carbide formed is tapped in molten form via taps at the lower end of the electric low shaft furnace, then cooled and broken to the desired particle size. After being tapped, the calcium carbide still has an intrinsic temperature of up to 1900° C. This perceptible heat forms up to 80% of the total energy required for the production process and in the cooling down process is usually practically entirely lost by being radiated into the environment.

Electrothermic processes in electric low shaft furnaces are very cost-intensive. On the one hand, enormous amounts of current are necessary for generating the reaction temperature, and on the other, high-quality coke is required, which first has to be obtained in coke plants from coal using complicated processes.

In such coke plants, coke and raw gas are generated from coal by means of a dry distillation process. The volatile ingredients in the coal are pyrolized by heating in the exclusion of oxygen to a temperature of 900° C. to 1400° C., then released and extracted by suction. Meanwhile, there are also coke plants where the released ingredients are combusted. This process is called the “heat recovery” process. The degassing of the coal forms a porous coke, which essentially contains carbon. The raw gas is broken down by fractionated condensation into the so-called valuable carbon materials of tar, sulfuric acid, ammonia, napththalene and benzene, which are further processed in chemical plants. Coking gas (synthesis gas) also occurs, which as a rule is used as fuel gas for indirect heating of the furnace chambers in which the coal coking takes place.

In the case of crude iron production, coke plants are often directly integrated into steel plants, where the blast-furnace gas produced from the blast furnace process can also be used as fuel for the coking.

A substantial disadvantage of the coking process is its low energy efficiency. The red-hot coke, after leaving the furnace chambers, must immediately be quenched with water, to prevent combustion in the air atmosphere. In the process, the perceptible heat of the heated coke is lost. For every metric ton of coke, up to 2 metric tons of water must be employed, and the resultant water vapor and the quenching water that occurs lead to increased emissions.

Moreover, the result is a raw gas that contains extreme quantities of tar and oil, which necessitates complicated processing of the gas, using a plurality of physical and chemical steps. A further substantial disadvantage is that this gas preparation is quite specifically designed for the pollutants or accompanying substances in the usual qualities of fat coal and brown coal, and particular the use of secondary carbon bearers, such as halogen-containing plastics or contaminated old wood, cannot be employed.

Not only in carbothermic or electrothermic processes for producing crude iron or primary products but also in the upstream coking of the coal, synthesis gases occur as a coke product in various compositions and with various calorific values.

The synthesis gases produced in the coking of coal in the exclusion of oxygen are typically of quite high quality and have a high calorific value, while the synthesis gas from the blast furnace process (blast-furnace gas) has a carbon dioxide content of up to 25 vol. %. It is therefore a less valuable synthesis gas, which can usually be used only as a weak fuel gas for coal coking.

In steel plants, the two gas qualities are therefore usually handled in separate gas networks.

As a rule, at locations where crude iron is produced there is an inadequate supply of requisite energy or high-quality synthesis gases. This is especially true in steel plants, where it is usually necessary to purchase a considerable amount of valuable fossil energy carriers, such as natural gas.

Both in electrothermic production processes and in the upstream coking of coal, synthesis gases are produced. They can be obtained as co-products and used both materially and thermally in downstream processes. As a result, the efficiency of the electrothermic process can be improved.

In the past, numerous attempts have been made to increase the energy efficiency of such electrothermic processes and to lower costs on the raw material side.

In German patent disclosure DE 4241246 A1, a process is proposed I which, beginning with plastic waste, coking is performed at 600 to 1400° in a chamber furnace. The resultant carbon component can then be used in the carbide process, while the resultant waste gas, after dust removal, is used for conversion into electrical energy by combustion in a steam boiler and an ensuing steam turbine.

A further process is proposed by DE 4241245 A1. Here as well, comminuted plastic waste is used as the carbon component; the waste is processed beforehand in the presence of small-particle calcium oxide by pyrolysis at 400 to 800° C. and then by calcination of the resultant calcium oxide/pyrolysis coke mixture processed in advance at 1000 to 1300° C. in the drum-type furnace, before the resultant carbon component can be used in the carbide process.

A similar process is disclosed in DE 4241244 A1, while DE 4241243 A1 contemplates the pyrolysis of plastic waste 600 to 1000° C., and the thus-obtained pyrolysis gas is partially combusted at 1200 to 1900° C., and finally the mixture of soot and gas is cooled down to 450 to 800° C., or the soot is precipitated out along with fine-particle and/or coarse calcium oxide.

A disadvantage of the aforementioned processes was the lack of technical capability of implementation, particularly of the various upstream pyrolysis stages using chamber or drum-type furnaces. Such processes, because of many technical problems, such as with the delivery of material to the hot zone, with continuous discharge of the solid residues, the formation of oils and tars, and other technical problems of the process, have been unable to become established or cannot be operated under economical peripheral conditions.

DE 10 2006 023 259 A1 proposes a process in which either residues that contain plastic or waste substances are used directly with the raw material mixture in the carbide process; they are preferably mixed beforehand with quick lime and coke and then delivered as a finished batch to the electric low shaft furnace. Because of the high proportion of quick lime in the batch, the process also makes it possible to use halogen-containing ingredients, such as PVC. In this process, the quantity of synthesis gas occurring in the carbide process is increased markedly, while the pyrolysis coke produced can be materially used as a carbon component for forming the calcium carbide.

However, it is disadvantageous that the necessary additional energy for pyrolysis of the residues and waste substances has to be furnished by means of expensive electric current. It is also a major disadvantage that the pollutants contained in the residues and waste substances are at least partially enriched in the calcium carbide, which makes further use more difficult.

A further principle is disclosed in DE 10 2007 054 343 A1. Here, PVC-containing plastic waste is thermally decomposed, for instance using an oil bath or an externally heated extruder at 250 to 500° C., forming HCl gas. The remaining carbon-containing residue is then used in the second stage as a carbon bearer in the carbide process. Again it is a disadvantage of this method that pollutants, especially heavy metals, remain in the carbon-containing residue and in the carbide process lead at least partially to an enrichment of heavy metal in the final product. Moreover, in the thermal decomposition there is the danger that toxic dioxins and furans will be formed, because of the presence of a high concentration of chlorine and bound oxygen, which can be thermally released from the chlorine-containing plastic waste.

In DE 10 2007 062 414.1-24, a process for gasification of carbon-rich substances is described, which proposes the conversion of the most various carbon bearers into synthesis gas, using a countercurrent gasifier. This process uses a bulk material, carried in circulation, as a reaction moving bed; preferably, alkaline substances, particular calcium oxide (CaO), are added as fine material, or all of the bulk material even comprises CaO. A further essential feature of this process is the development of a cooling zone, in which the requisite gasification media, such as air and/or water, are preheated in an energy-efficient way, while the bulk material carried in circulation is being cooled down. As a result, very high energy efficiency can be achieved; however, the enormous effort involved in bringing about the circulation of the bulk material is a disadvantage. In particular, the continuous particle destruction can be disadvantageous, since fine material may possibly have to be transferred outward beyond the desired extent.

Taking the prior art described of the carbothermic production process for crude iron into account, with its undersupply of synthesis gas, as well as gasification processes in countercurrent gasifiers using bulk material as a reaction moving bed, it has become the object of the present invention to furnish a novel carbothermic process for producing crude iron that has a markedly increased amount of energy efficiency, furnishes high-quality synthesis gas, and lessens the disadvantages of coal coking because pollutants are essentially bound in a more environmentally friendly way, and a broader spectrum of carbon-containing materials, and especially even polluted carbon-bearers, as well as biomasses can be made accessible as feedstock.

This is attained according to the invention in that the iron ore, oxides and/or carbonates of calcium, before being used in the blast furnace, are first used as bulk material entirely or in part in an vertical moving-bed reactor embodied as a countercurrent gasifier. The bulk material in the moving-bed reactor additionally has a proportion of alkaline substances, and the moving-bed reactor is equipped with a reduction zone and an oxidation zone. Besides the bulk material and the alkaline substances, organic materials are used, which are converted entirely or in part into synthesis gas by gasification on the countercurrent principle with oxygen-containing gases. The bulk material that remains as a residue in this gasification is furnished at least partially as a mixture of raw materials for the carbothermic production of crude iron in the blast furnace.

The iron ore used, the oxides used, and/or the carbonates used are preferably used in coarse form, in order to reinforce an adequate gas permeability in the moving-bed reactor. It is understood that it is also possible to use agglomerates of these materials, such as granulates, pellets or briquettes, in the moving-bed reactor. Such pellets are produced today already purposefully in the iron and steel industry, using calcium oxide, among others, as a binder, so as to make even fine-grain iron ore accessible to processing by the blast furnace process.

For binding pollutants, such as sulfur, halogens, or heavy metals, it is advantageous to admix alkaline substances, such as coarse calcium oxide, with the bulk material in the moving-bed reactor as well. It is especially preferable to admix powdered calcium oxide and/or calcium hydroxide, since in that case considerably larger reaction surface areas, as well as alkaline substances as pollutant binders, are made available in the gas phase.

The use of calcium oxide offers the advantage particular that its catalytic action can be virtually ideally exploited in the gasification of organic materials. This catalytic action reduces the oil- and tar-like products that otherwise occur upon gasification or coking to a minimum, while at the same time the thermal breakdown ensues at lower temperatures and leads to a markedly increased yield of synthesis gas.

For optimal control of the gasification, the moving-bed reactor is preferably equipped with a backup furnace in the vicinity of the oxidation zone. This firing can be operated via burner lances with fuel and with oxidation gas. That serves on the one hand to put the gasification process into operation and during the standardized operation serves on the other hand to fix the oxidation zone in the shaft of the moving-bed reactor. The control can be done here such that the oxidation gas, in the form of air and/or oxygen, can be added stoichiometrically or even superstiochiometrically relative to the fuel in the lances. As a result, even the complete metering in of the quantity of oxidation gas required in the gasification process can be done via the lances.

The requisite amount of oxidation gas in the moving-bed reactor can be adjusted by the addition of air and/or technical oxygen; the quantity of air or oxygen is adjusted such that over all the stages of the gasification results in a total lambda of less than 1, preferably less than 0.7, and especially preferably less than 0.5.

In order maximally to reduce the development of oil- or tar-containing breakdown products from the catalytic effect of the calcium oxide, it is possible to perform a calcium-catalyzed reformation above 400° C. in the vertical process chamber and/or in the gas phase of the drawn-off gaseous reaction products in the presence of water vapor and calcium oxide and/or calcium carbonate and/or calcium hydroxide. In the process, substantial proportions of the resultant oil- and/or tar-containing breakdown products, which have a chain length of greater than C4, are converted into carbon monoxide, carbon dioxide, and hydrogen.

The required water vapor can be metered in purposefully into the vertical process chamber and/or into the gas phase above the reduction zone. An embodiment in which water vapor is furnished in situ from the residual moisture of the organic materials is also advantageous. In that case, it may be possible to entirely dispense with metering in water.

Fundamentally, the bulk material remaining behind in the moving-bed reactor can be used without intermediate cooling, while extensively utilizing its perceptible heat in the process.

A preferred embodiment of the process of the invention provides that the moving-bed reactor has a cooling zone below the oxidation zone, and cooling gas is metered in at the lower end of the moving-bed reactor and is carried in countercurrent to the moving bulk material bed.

The oxygen-containing gas, in the form of air and/or oxygen, can function here as cooling gas, which is metered in at least partially at the lower end of the moving-bed reactor and is carried in countercurrent through the cooling zone. It is important here that the total lambda over the total quantity of oxygen-containing gas is set so high that complete oxidation of still remaining residual coke from the gasification of the organic materials takes place in the oxidation zone. In the gasification of organic materials, depending on their molecular proportion of carbon to hydrogen, different specific residual coke quantities remain behind. This residual coke, when oxygen-containing gas is used in the cooling zone, should already be oxidized in the oxidation zone completely into CO or CO₂. Otherwise, the oxidation would take place with the cooling gas in the cooling zone and would trip an opposite effect because of the reaction heat released.

It is especially preferable to use CO₂-containing gases, preferably synthesis gas from the blast furnace (blast-furnace gas) as the cooling gas. This cooling gas is metered in at the lower end of the moving-bed reactor and carried in the cooling zone in countercurrent to the hot bulk material.

This kind of procedure creates an especially energy-efficient embodiment of the process of the invention, since in this case it is necessary that the total lambda be set so low that residual coke from the gasification of the organic materials still remains after leaving the oxidation zone, and it can be used at least partially for reducing the CO₂ contained in the CO₂-containing gases used as cooling gas, by means of a Boudouard reaction into CO, before the remaining coke together with the bulk material is then further cooled down by the cooling gas.

This embodiment can be optimized, by purposeful process management, to such an extent that the gasification process is shifted to a considerable extent toward coking, and along with a reduced quantity of synthesis gas, a markedly increased proportion of coke is generated from the organic materials. This coke can then at least partly replace the necessary coke derived from fossil resources in the process. The particular advantage is that the coke can be generated from the most various organic materials, and there is no need to use fossil sources of carbon. However, it is very particularly advantageous that because of the use of blast-furnace gas, the energy losses from the otherwise necessary coke quenching with water vapor can be dispensed with; at the same time, by utilizing both the perceptible heat and the reduction effect of the coke, an extraordinarily energy-efficient increase in the gross calorific value of the blast-furnace gas, and thus overall a significant increase in energy efficiency of crude iron production, can be achieved.

The organic materials used may, as already explained above, contain pollutants. The pollutants are preferentially bound to the fine or powdered alkaline substances.

It is therefore preferable that downstream of the moving-bed reactor, screening of the bulk material that remains behind be done to separate out fine material and ash, before the coarse screening fraction of the bulk material is used in the blast furnace or electric low shaft furnace.

Here it can be advantageous that the screened-out fine material is at least partially re-used in the moving-bed reactor and thus carried in circulation. As a result, the stationary concentration of fine material in the moving-bed reactor can be increased, or an intentional enrichment of pollutants in the fine material can be achieved.

It can furthermore be advantageous that the screened-out coarse screening fraction of the bulk material is at least partially re-used in the moving-bed reactor and thus carried in circulation. As a result, the proportion of bulk material to the organic materials used can be adjusted entirely independently of the requisite proportion required for use in the blast furnace or electric low shaft furnace. This has the advantage that the stationary bulk material quantity in the moving-bed reactor, for instance, can be increased compared to the quantity of organic materials, if unfavorable physical properties of the organic materials, for instance melting plastics or bituminous materials, necessitate this.

For the process management in the gasification, it can be advantageous that along with oxygen-containing gas in the moving-bed reactor, water and/or water vapor is additionally supplied as a gasification medium, preferably below the oxidation zone and/or into the oxidation zone.

As already discussed above, it is advantageous in the gas phase as well to furnish a sufficient concentration of powdered alkaline substances in the process. It is therefore expedient that the synthesis gas formed in the moving-bed reactor be drawn off at the upper end, and the dust contained in the synthesis gas be isolated from the synthesis gas at temperatures above 300° C. by physical removal of suspended solids.

The dust isolated from the synthesis gas in this way can, analogously to the screened-off fine material, also be re-used at least partially in the moving-bed reactor by being added to the bulk material and thus carried in circulation.

It is a substantial advantage of the process of the invention that the most various organic materials can be used in the moving-bed reactor for the synthesis gas generation and for generating coke for crude iron production or for the electrothermic process.

In particular, for the first time, materials the use of which for such processes was previously avoided because of the amounts of pollutants they contain, can be made accessible for crude iron production.

These materials include wastes that contain plastic, for instance, and especially also halogen-containing fractions from community and/or commercial wastes. Such wastes can for the first time, by means of the process of the invention, also be utilized materially by being used in crude iron production.

Further, the most various biomasses, such as old wood or other biogenic waste streams, can be used. Thus the possibility is opened up for the iron and steel industry to replace fossil carbon bearers previously used at least partially with CO₂-neutral renewable resources.

Because of the pronounced binding capability of the alkaline substances in the moving-bed reactor, even markedly sulfur-containing carbon bearers can be used, such as petrol coke and/or bitumen-containing materials. The use of brown coal and/or brown coal briquettes in the moving-bed reactor is also possible.

Below, in conjunction with the accompanying drawings, exemplary embodiments of the invention will be addressed in further detail. In drawings:

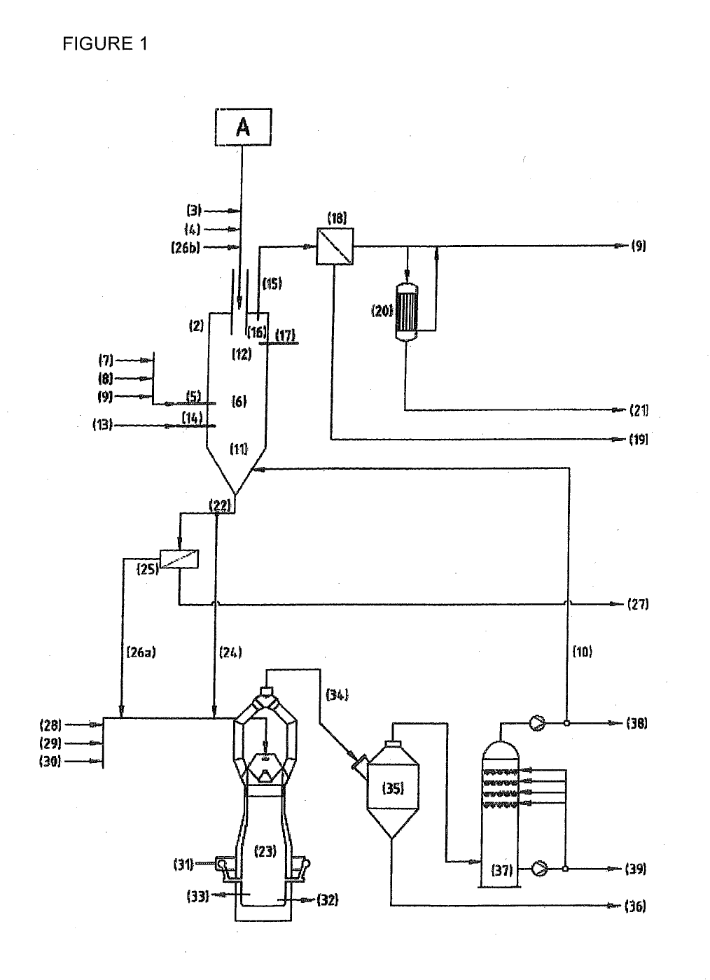

FIG. 1 shows a preferred embodiment of a carbothermic process in a steel plant;

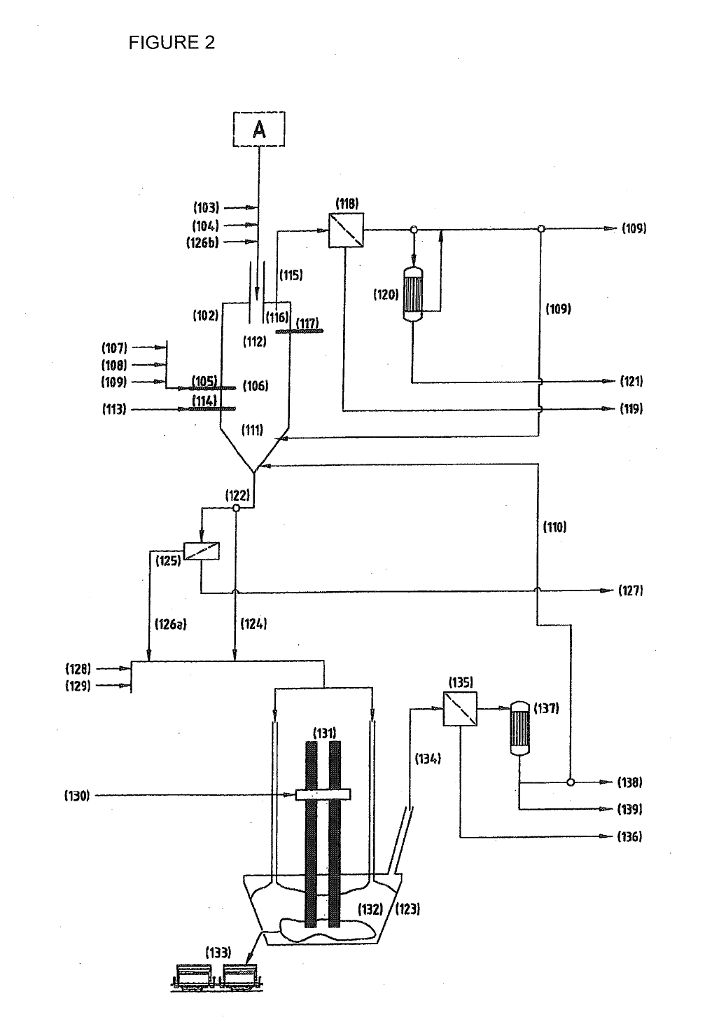

FIG. 2 shows a preferred embodiment of an electrothermic process in a calcium carbide plant.

As shown in FIG. 1, a mixture, intended as raw materials for the blast furnace process, of iron ore and calcium oxide (A) in coarse form and with a particle size of less than 30 cm is supplied from above via a vertical chute to a countercurrent gasifier (2), which is embodied as a vertical process chamber. This mixture forms a moving bulk material bed.

To this moving bulk material bed, before entry into the countercurrent gasifier (2), organic materials (3) are mixed in, for instance plastic-containing wastes or biomasses, for instance in the form of old wood. For later binding of the pollutants, such as chlorine and heavy metals, contained in the organic materials, alkaline substances (4), preferably fine-granular calcium oxide, are mixed into the moving bulk material bed before entry into the countercurrent gasifier (2).

The mixture of iron ore, calcium oxide, organic materials and alkaline substances flows through the vertical process chamber (2) by their own gravity from the top downward. The countercurrent gasifier has burner lances (5) in its middle region, which provide for base load firing in the vertical process chamber and for the stationary development of an oxidation zone (6). These burner lances can be operated with fossil fuels (7) and oxygen-containing gas (8). Alternatively to the fossil fuels, synthesis gas from the countercurrent gasifier (9) can also be used.

At the lower end of the vertical process chamber, blast-furnace gas (10) from the blast furnace process is introduced as cooling gas. This gas serves initially for cooling the bulk material before it leaves the vertical process chamber, in a cooling zone (11). In the process the blast-furnace gas is heated as it flows further upward in the vertical process chamber.

The burner lances (5) are operated such that the quantity of oxygen-containing gas (8) is used superstoichiometrically, referred to the fuel (7). Because of the resultant oxygen excess in the oxidation zone, the blast-furnace gas flowing into the oxidation zone (6) from the cooling zone (11) is at least partially combusted and in the process forms further carbon dioxide and water vapor. By the reaction heat that is released, the energy necessary for the gasification process is made available.

In accordance with the countercurrent gasification principle, the carbon dioxide and the water vapor from the blast-furnace gas combustion react in the reaction zone (12) with the coke that occurs from the organic materials, forming carbon monoxide and hydrogen.

The amount of blast-furnace gas is adjusted such that on the one hand the moving bulk material bed is cooled down completely in the cooling zone (11), and any residual embers are quenched, and on the other, the highest possible proportion of necessary process energy is covered by the blast-furnace gas.

The quantity of oxygen-containing gas introduced via the burner lances (5) is adjusted such that in the vertical process chamber, a total lambda of preferably less than 0.5 is established. As a result, initially an oxidation zone (6) develops, in which combustible components of the blast-furnace gas and residues of the organic material react with oxygen to form CO₂ and H₂. Farther up in the process chamber, there is less and less oxygen and thus finally only low-temperature carbonization can take place, until still farther upward, finally, all the oxygen has been consumed, and a reduction zone (12) develops, under completely reductive conditions.

Conversely, if one looks at the flow of the bulk material mixture, comprising iron ore, calcium oxide, organic materials and alkaline substances, from top to bottom, then what occurs first in the reduction zone (12) is drying of the possibly moist materials used, until an intrinsic temperature of 100° C. After that, the intrinsic temperature of the materials rises further, so that the gasification process of the plastics contained in the organic materials begins, and at an intrinsic temperature of up to 500° C., the formation of methane, hydrogen and CO ensues. After extensive degasification, the intrinsic temperature of the materials rises further as a result of the hot gases rising out of the oxidation zone (6), so that finally, the organic materials are completely degasified and now comprise only residual coke, so-called pyrolysis coke, as well as ash ingredients. In the vertical process chamber the pyrolysis coke along with the bulk material is transported farther downward, where along with the CO₂ components from the oxidation zone (6), it is converted at least partially into CO at temperatures above 800° C. in the reduction zone (12) by means of a Boudouard reaction. Some of the pyrolysis coke also reacts in this zone by the water-gas reaction with water vapor, which is likewise contained in the hot gases, forming CO and hydrogen.

Residues of the pyrolysis coke are finally oxidized at temperatures below 1800° C. in the oxidation zone (6) with the oxygen-containing gas (8) flowing in via the burner lances and thermally used.

The moving bulk material bed arrives, together with the remaining ash components, in the cooling zone (11).

Water (13) can also be metered into the cooling zone (11) via water lances (14), as a further cooling and gasification medium.

The synthesis gas formed in the vertical process chamber is extracted by suction (15) at the upper end, so that in the upper gas chamber (16) of the vertical process chamber, a slight underpressure of from 0 to −200 mbar is preferably established.

During the gasification process, depending on the quality of the substances used, considerable proportions of gaseous acidic halogen-containing gases, or halogens, can occur. It is therefore advantageous if alkaline substances (4) are admixed with the moving bulk material bed before entry into the vertical process chamber. Metal oxides, metal hydroxides or metal carbonates are especially suitable for this; the use of fine-granular calcium oxide is especially preferred, since because of its reactivity and large surface area it reacts spontaneously with the gaseous halogen compounds or halogens formed and in the process forms solid salts, which very predominantly are discharged from the vertical process chamber along with the synthesis gas that is extracted by suction. Still other pollutants, such as chlorine, hydrogen chloride or even volatile heavy metals, can also be bound very effectively to the calcium oxide and in the same way discharged from the process.

The synthesis gas extracted by suction contains dust, which essentially comprises the solid salts of halogens, fine-granular alkaline substances, further pollutants, and inert particles. The synthesis gas containing dust can be treated in the gas chamber (16) of the vertical process chamber, or at (15) after leaving the vertical process chamber, in the presence of water vapor and fine-granular calcium oxide at temperatures of above 400° C. This temperature can be established by means of suitable adjustment of the quantity of oxygen-containing gas (8) or by the heating capacity of the burner lances (5) in the oxidation zone (6). However, it is especially advantageous to use direct firing into the synthesis gas via burner lances (17), which are operated stoichiometrically with fuel and oxygen-containing gas or even with an excess of oxygen-containing gas. This thermal posttreatment in the presence of water vapor and calcium oxide ensures the breakdown of oils and tars still present in slight quantities in the synthesis gas, by means of catalytic action of the calcium oxide.

The synthesis gas containing dust is then freed of the dust at temperatures above 300° C. via hot gas filtration (18). The halogen-containing filter dust (19) is transferred outward of the process. In a preferred embodiment of the process, it is also possible for the filter dust, at least partially, to be admixed again with the bulk material at (4) in the form of fine-granular alkaline substances and thereby to achieve a partial circulatory motion of the filter dust.

The resultant synthesis gas (9) is practically halogen-free and can be furnished as raw material or fuel for the most various applications. In particular, in the steel plant it can be added to the already present synthesis gas network, for instance to the coke plant gas, and utilized internally in the plant.

Depending on location conditions or requirements in the further use of the synthesis gas, it may be necessary to cool down the synthesis gas by means of gas coolers (20) and free it of condensates, before its further use can ensue. The condensate (21) that occurs can be at least partially used re-used as a cooling and gasification medium via the water lances (14) in the vertical reaction chamber.

The bulk material mixture (22) exiting at the lower end of the vertical reaction chamber essentially contains coarse-granular bulk material, ash residues, and fine-granular calcium oxide.

The entire bulk material stream can be transferred outward at (24) from the overall process for use as feedstock in downstream blast furnaces (23). However, it is especially preferable for the bulk material mixture (25) to be screened, with the coarse fraction (26a) advantageously used as feedstock in the blast furnace (23). However, it can also be advantageous to use some of the coarse fraction at (26b) again as bulk material in the moving-bed reactor (2) and to put it into circulation. As a result, it is possible to adjust the proportion of bulk material to the organic materials used independently over a wide range.

The fine screening fraction (27) contains residues of ash and fine-granular calcium oxide.

Here, in a preferred embodiment of the process, it is possible for the fine screening fraction at least partially to be admixed again as fine-granular alkaline substances with the bulk material at (4) and thereby to achieve a partial circulatory mode of the fine screening fraction.

In the blast furnace (23), the coarse material is optionally supplemented with further iron ore (28), coke (29), and lime (30), and by the addition of hot wind (31) for crude iron to be obtained by reduction of the ores and tapped as a melt at (32). The resultant slag is tapped in molten form as well at (33), above the crude iron tap.

The resultant blast-furnace gas (34) is freed of dust in a dust precipitator (35), and the dust is settled out (36). After that, the blast-furnace gas is cleaned in a gas washer (37) and delivered for use inside the steel plant at (38). The wastewater (39) from the gas washer is processed internally and/or at least partially carried in circulation.

With a view to an electrothermic production process of FIG. 2, the calcium oxide (A) provided as raw material, in coarse form and with a particle size of less than 30 cm, is delivered to a countercurrent gasifier (102), which is embodied as a vertical process chamber, from above via a vertical chute. This forms a moving bulk material bed.

Before entering the countercurrent gasifier (102), organic materials (103), such as wastes containing plastic, or biomasses, for instance in the form of old wood, are admixed with the moving bulk material bed. For later binding of the pollutants, such as chlorine, sulfur and heavy metals, contained in the organic materials, alkaline substances (104), preferably fine-granular calcium oxide, are admixed with the moving bulk material bed before entry into the countercurrent gasifier (102).

The mixture of calcium oxide, organic materials and alkaline substances flows through the vertical process chamber (102) from top to bottom by its own gravity. The countercurrent gasifier, in its middle region, has burner lances (105), which ensure base load firing in the vertical process chamber and the stationary development of an oxidation zone (106). These burner lances can be operated with fossil fuels (107) and oxygen-containing gas (108). Alternatively to the fossil fuels, synthesis gas from the countercurrent gasifier (109) can also be used.

At the lower end of the vertical process chamber, synthesis gas (110) is introduced as cooling gas from the electric low shaft furnace process or from the countercurrent gasifier (109). This gas serves first to cool the bulk material before leaving the vertical process chamber, in a cooling zone (111). In the process the synthesis gas is preheated, while it continues to flow upward in the vertical process chamber.

The burner lances (105) are operated such that the quantity of oxygen-containing gas (108) is used superstoichiometrically, relative to the fuel (107). Because of the resultant oxygen excess in the oxidation zone (106), the blast-furnace gas flowing out of the cooling zone (111) into the oxidation zone (106) is at least partially combusted and in the process forms further carbon dioxide and water vapor. In the process, because of the reaction heat released, the energy required for the gasification process is made available.

In accordance with the countercurrent gasification principle, the carbon dioxide and the water vapor from the synthesis gas combustion react in the reaction zone (112) with the coke that occurs from the organic materials, forming carbon monoxide and hydrogen.

The amount of synthesis gas is adjusted such that on the one hand the moving bulk material bed is cooled down completely in the cooling zone (111), and any residual embers are quenched, and on the other, the highest possible proportion of necessary process energy is covered by the synthesis gas.

The quantity of oxygen-containing gas introduced via the burner lances (105) is adjusted such that in the vertical process chamber, a total lambda of preferably less than 0.5 is established. As a result, initially an oxidation zone (106) develops, in which combustible components of the synthesis gas and residues of the organic material react with oxygen to form CO₂ and H₂. Farther up in the process chamber, there is less and less oxygen and thus finally only low-temperature carbonization can take place, until still farther upward, finally, all the oxygen has been consumed, and a reduction zone (112) develops, under completely reductive conditions.

Conversely, if one looks at the flow of the bulk material mixture, comprising iron ore, calcium oxide, organic materials and alkaline substances, from top to bottom, what occurs first in the reduction zone (112) is drying of the possibly moist materials used, until an intrinsic temperature of 100° C. After that, the intrinsic temperature of the materials rises further, so that the gasification process of the plastics contained in the organic materials begins, and at an intrinsic temperature of up to 500° C., the formation of methane, hydrogen and CO ensues. After extensive degasification, the intrinsic temperature of the materials rises further as a result of the hot gases rising out of the oxidation zone (106), so that finally, the organic materials are completely degasified and now comprise only residual coke, so-called pyrolysis coke, as well as ash ingredients. In the vertical process chamber the pyrolysis coke along with the bulk material is transported farther downward, where along with the CO₂ components from the oxidation zone (106), it is converted at least partially into CO at temperatures above 800° C. in the reduction zone (112) by means of a Boudouard reaction. Some of the pyrolysis coke also reacts in this zone by the water-gas reaction with water vapor, which is likewise contained in the hot gases, forming CO and hydrogen.

Residues of the pyrolysis coke are finally oxidized at temperatures below 800° C. in the oxidation zone (106) with the oxygen-containing gas (108) flowing in via the burner lances and thermally used.

The moving bulk material bed arrives, together with the remaining ash components, in the cooling zone (111).

Water (113) can also be metered into the cooling zone (111) via water lances (114), as a further cooling and gasification medium.

The synthesis gas formed in the vertical process chamber is extracted by suction (115) at the upper end, so that in the upper gas chamber (116) of the vertical process chamber, a slight underpressure of from 0 to −200 mbar is preferably established.

During the gasification process, depending on the quality of the substances used, considerable proportions of gaseous acidic halogen-containing gases, or halogens, can occur. It is therefore advantageous if alkaline substances (104) are admixed with the moving bulk material bed before entry into the vertical process chamber. Metal oxides, metal hydroxides or metal carbonates are especially suitable for this; the use of fine-granular calcium oxide is especially preferred, since because of its reactivity and large surface area it reacts spontaneously with the gaseous halogen compounds or halogens formed and in the process forms solid salts, which very predominantly are discharged from the vertical process chamber along with the synthesis gas that is extracted by suction. Still other pollutants, such as chlorine, hydrogen chloride or even volatile heavy metals, can also be bound very effectively to the calcium oxide and in the same way discharged from the process.

The synthesis gas extracted by suction contains dust, which essentially comprises the solid salts of halogens, fine-granular alkaline substances, further pollutants, and inert particles. The synthesis gas containing dust can be treated in the gas chamber (116) of the vertical process chamber, or at (115) after leaving the vertical process chamber, in the presence of water vapor and fine-granular calcium oxide at temperatures of above 400° C. This temperature can be established by means of suitable adjustment of the quantity of oxygen-containing gas (108) or by the heating capacity of the burner lances (105) in the oxidation zone (106). However, it is especially advantageous to use direct firing into the synthesis gas via burner lances (117), which are operated stoichiometrically with fuel and oxygen-containing gas or even with an excess of oxygen-containing gas. This thermal posttreatment in the presence of water vapor and calcium oxide ensures the breakdown of oils and tars still present in slight quantities in the synthesis gas, by means of catalytic action of the calcium oxide.

The synthesis gas containing dust is then freed of the dust at temperatures above 300° C. via hot gas filtration (118). The halogen-containing filter dust (119) is transferred outward of the process. In a preferred embodiment of the process, it is also possible for the filter dust, at least partially, to be admixed again with the bulk material at (104) in the form of fine-granular alkaline substances and thereby to achieve a partial circulatory motion of the filter dust.

The resultant synthesis gas (109) is practically halogen-free and can be furnished as raw material or fuel for the most various applications. In particular, in the steel plant it can be added to the already present synthesis gas network, for instance to the coke plant gas, and utilized internally in the plant.

Depending on location conditions or requirements in the further use of the synthesis gas, it may be necessary to cool down the synthesis gas by means of gas coolers (120) and free it of condensates, before its further use can ensue. The condensate (121) that occurs can be at least partially used re-used as a cooling and gasification medium via the water lances (114) in the vertical reaction chamber.

The bulk material mixture (122) exiting at the lower end of the vertical reaction chamber essentially contains coarse-granular bulk material, ash residues, and fine-granular calcium oxide.

The entire bulk material stream can be transferred outward at (124) from the overall process for use as feedstock in downstream blast furnaces (123). However, it is especially preferable for the bulk material mixture (25) to be screened, with the coarse fraction (126a) advantageously used as feedstock in the blast furnace (123).

However, it can also be advantageous to use some of the coarse fraction at (126b) again as bulk material in the moving-bed reactor (102) and to put it into circulation. As a result, it is possible to adjust the proportion of bulk material to the organic materials used independently over a wide range.

The fine screening fraction (127) contains residues of ash and fine-granular calcium oxide.

Here, in a preferred embodiment of the process, it is possible for the fine screening fraction at least partially to be admixed again as fine-granular alkaline substances with the bulk material at (104) and thereby to achieve a partial circulatory mode of the fine screening fraction.

In the electric low shaft furnace (123), the coarse material is optionally supplemented with further calcium oxide (128) and coke (129). By means of electrical energy (130), via Söderberg electrodes (131), the resistance heating in the electric low shaft furnace (123) is achieved, which at the tip of the electrodes develops a melt zone (132), in which the reaction process proceeds, and molten calcium carbide occurs. The calcium carbide is tapped as melt at (133) and caught in mobile cooling pans.

The resultant carbide furnace gas (synthesis gas) (134) is freed of dust in a dust precipitator (135), and the dust is precipitated out (136). After that, the carbide furnace gas is cooled down in a gas cooler (137) and delivered (138) to its use inside the carbide plant. The condensate (139) from the gas cooler is processed internally.

1. A process for carbothermic/electrothermic production of crude iron or other primary products in blast furnaces or electric low shaft furnaces by using mixtures comprising iron ore, oxides and/or carbonates of calcium (A) and carbon-containing materials, forming carbon monoxide-containing gases, characterized in that the iron ore, oxides and/or carbonates of calcium are used entirely or in part as bulk material together with organic materials, first in an vertical moving-bed reactor embodied as a countercurrent gasifier, which as its moving bed has a bulk material at least partly comprising alkaline substances, a reduction zone and an oxidation zone, which converts the organic materials entirely or in part by gasification with oxygen-containing gases into synthesis gas, and the bulk material remaining behind is furnished at least partially as a mixture of raw materials for the carbothermic production of crude iron or electrothermic production of primary products.

2. The process of claim 1, characterized in that iron ore, oxides and/or carbonates of calcium are used in coarse form and/or as iron-containing agglomerates, for instance as granulates or briquettes, in the moving-bed reactor.

3. The process of claim 1, characterized in that in addition, alkaline substances, for instance coarse calcium oxide and especially preferably powdered calcium oxide and/or calcium hydroxide are additionally admixed with the bulk material in the moving-bed reactor.

4. The process of claim 1, characterized in that the moving-bed reactor has a backup furnace in the vicinity of the oxidation zone, which is operated with fuel and with oxygen-containing gas via burner lances.

5. The process of claim 1, characterized in that in the moving-bed reactor and/or in the gas phase of the drawn-off gaseous reaction products, in the presence of water vapor and calcium oxide and/or calcium carbonate and/or calcium hydroxide, a catalytic reformation of substantial proportions of the resultant oil- and/or tar-containing breakdown products, which have a chain length of greater than C4, into carbon monoxide, carbon dioxide and hydrogen is performed at temperatures of above 400° C.

6. The process of claim 1, characterized in that the bulk material remaining behind in the moving-bed reactor is used, without intermediate cooling, with extensive utilization of its perceptible heat, in the blast furnace or in the electric low shaft furnace.

7. The process of claim 1, characterized in that the moving-bed reactor has a cooling zone below the oxidation zone, and cooling gas is metered in at the lower end of the moving-bed reactor and is carried in countercurrent to the moving bulk material bed.

8. The process of claim 1, characterized in that the gasification in the moving-bed reactor is effected by the addition of air and/or technical oxygen as the oxygen-containing gas, and the quantity of air or oxygen is adjusted such that over all the stages of the gasification, a total lambda of less than 1, preferably less than 0.7, and especially preferably less than 0.5 results.

9. The process of claim 8, characterized in that the oxygen-containing gas in the form of air and/or oxygen is metered in at least partially at the lower end of the moving-bed reactor, and used as cooling gas in the cooling zone, and in the process the total lambda is set so high that complete oxidation of still-remaining residual coke from the gasification of the organic materials is effected in the oxidation zone.

10. The process of claim 9, characterized in that CO₂-containing gases, preferably synthesis gas from the blast furnace, the electric low shaft furnace and/or the moving-bed reactor, are metered in at the lower end of the moving-bed reactor and used in the cooling zone as cooling gas.

11. The process of claim 9, characterized in that the total lambda is set so low that residual coke from the gasification of the organic materials still remains after leaving the oxidation zone, and it is used at least partially for reducing the CO₂ contained in the CO₂-containing gases used as cooling gas, by means of a Boudouard reaction into CO, before the remaining coke together with the bulk material is then further cooled down by the cooling gas.

12. The process of claim 1, characterized in that downstream of the moving-bed reactor, a screening of the bulk material remaining behind is effected to separate off fine material and ash, before the coarse screening fraction of the bulk material in the blast furnace or in the electric low shaft furnace is used for the carbothermic production of crude iron or of the primary products.

13. The process of claim 12, characterized in that the screened-out fine material is re-used at least partially in the moving-bed reactor at and is thus carried in circulation.

14. The process of claim 12, characterized in that the screened-out coarse material is re-used at least partially in the moving-bed reactor at and is thus carried in circulation.

15. The process of claim 1, characterized in that in addition, water and/or water vapor as gasification media are supplied to the moving-bed reactor, preferably below the oxidation zone at and/or into the oxidation zone.

16. The process of claim 1, characterized in that the synthesis gas formed in the moving-bed reactor is drawn off at the upper end at, and the dust contained in the synthesis gas is isolated from the synthesis gas at temperatures above 300° C. by physical removal of suspended solids.

17. The process of claim 16, characterized in that the dust isolated from the synthesis gas is re-used at least partially in the moving-bed reactor by addition to the bulk material at and is thus carried in circulation.

18. The process of claim 1, characterized in that in the moving-bed reactor, coal is used as organic materials, and the coking into coke is effected in the moving-bed reactor, using the energy from the organic materials and/or from the fuel/oxidation gas mixture from the backup furnace.
